(19) United States
(12) Patent Application Publication
(10) Pub. No.: US 2025/0232743 A1
(43) Pub. Date: Jul. 17, 2025

(54) ENHANCED COLOR DISPLAY

(71) Applicant: TOSHIBA GLOBAL COMMERCE SOLUTIONS, INC., Durham, NC (US)

(72) Inventors: Edna E. NOVIDO, Morrisville, NC (US); Prabhjot K. TOPIWALA, Holly Springs, NC (US)

(21) Appl. No.: 18/413,625

(22) Filed: Jan. 16, 2024

(51) Int. Cl. G09G 5/02; G09G 5/14

(52) U.S. Cl. CPC G09G 5/02; G09G 5/14; G09G 2320/0666; G09G 2354/00

(57) ABSTRACT

Method and apparatus for color enhancement are provided. An input is received, where the input indicates a selection of a color enhancement mode. A display of a self-service device is switched from a standard color mode to the selected color enhancement mode. The completeness of a transaction on the self-service device is detected. Responsive to the detection, the display of the self-service device is reverted from the selected color enhancement mode to the standard color mode.

### BACKGROUND

Color vision deficiencies, which can include conditions like red-green blindness, blue-yellow blindness, and complete color blindness, affect a considerable portion of the population. According to studies, approximately 1 in every 12 men and 1 in every 200 women are impacted by some form of color vision deficiency. This population group faces challenges in various aspects of daily life, especially when interacting with technologies that utilize color-based interfaces, such as self-service devices in retail environments. These devices, such as self-checkout stations and kiosks for interactive information searches, often use color displays for user guidance and feedback, which may create barriers for individuals with color vision deficiencies. Without color enhancement modes specially designed for their unique needs, these individuals may struggle to use these self-service devices effectively, leading to a less inclusive and potentially frustrating experience.

### BRIEF DESCRIPTION OF THE DRAWINGS

FIG. 1 depicts an example environment for color enhancement mode implementation, according to some embodiments of the present disclosure.

FIG. 2 depicts example Graphical User interfaces (GUIs) designed for interactive selection and adjustment of color enhancement modes, according to some embodiments of the present disclosure.

FIG. 3 depicts an example method for interactively selecting and adjusting color enhancement modes based on user preferences, according to some embodiments of the present disclosure.

FIG. 4 depicts an example method for generating customized color enhancement modes based on user preferences, according to some embodiments of the present disclosure.

FIG. 5 is a flow diagram depicting an example method for interactive selection and adjustment of color enhancement modes, according to some embodiments of the present disclosure.

FIG. 6 is a flow diagram depicting an example method for generation of customized color enhancement modes, according to some embodiments of the present disclosure.

FIG. 7 depicts an example computing device configured to perform various aspects of the present disclosure, according to some embodiments of the present disclosure.

To facilitate understanding, identical reference numerals have been used, where possible, to designate identical elements that are common to the figures. It is contemplated that elements disclosed in one embodiment may be beneficially used in other embodiments without recitation.

### DETAILED DESCRIPTION

People with color vision deficiencies often face challenges when entering a store and using self-service devices (e.g., kiosks, checkout devices), as these devices typically utilize color-based interfaces for guidance and feedback. The present disclosure provides approaches for automatically adjusting the color display settings of such self-service devices. The described enhancement can make such devices more accessible and user-friendly for customers with individual needs or preferences regarding color displays, in order to ensure a smoother interaction experience.

In one instance, the self-service devices may provide several default (or system-defined) color enhancement modes for customer selection, such as red-green color enhancement mode, blue-yellow color enhancement mode, and complete color enhancement mode. The default color enhancement modes are designed to improve the usability and accessibility of these devices for individuals with various types of color vision deficiencies. As customers approach these devices, they may select one of these default modes that best suits their individual needs. For example, a customer with red-green color blindness may choose the red-green color enhancement mode. After the selection, a preview window pops up, showing the changes in colors when the selected mode is implemented. The customer can then use the toolbars within the preview window to further customize the display settings to meet their visual requirements.

In another instance, instead of selecting the default (or system-defined) color enhancement modes, the self-service devices may offer an option that enables a customer to directly upload his or her color preferences (e.g., from a smartphone). Based on the preferences, the self-service device then generates a customized color enhancement mode. This approach allows for a more personalized interaction, as the customer may set up his or her color preferences in advance on the mobile device, and smoothly apply them to the self-service device upon connection.

After a customer confirms his or her selection, the default color enhancement mode (with or without adjustments) or the customized color enhancement mode is then implemented by the self-service device. The mode is maintained throughout one or more transactions for the customer. Upon detecting that the transactions are complete, the self-service device automatically reverts to the standard color mode. The smooth transition between the standard color mode and various color enhancement color modes enhances the accessibility of self-service systems, accommodating not only to users with special needs regarding color display but also to those without such requirements.

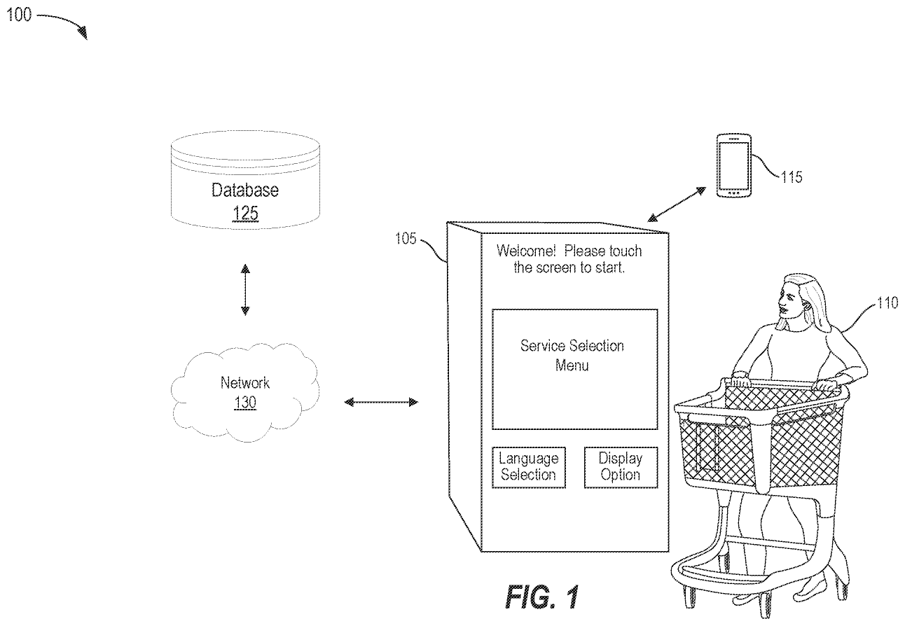

FIG. 1 depicts an example environment 100 for color enhancement mode implementation, according to some embodiments of the present disclosure.

In some embodiments, the environment 100 for color enhancement mode implementation may correspond to a retail establishment (e.g., a grocery store, a supermarket, an outlet mall, or a warehouse club). In the illustrated example, the environment 100 includes one or more self-service devices 105. In some instances, the self-service devices 105 may refer to any devices that enable users to perform tasks or access services independently without direct assistance from a human operator. In retail environments, the self-service device 105 may include self-checkout machines, kiosk stations for information search, automated vending machines, and the like. The self-service device may use color-based interfaces to guide users to access services or complete transactions. To assist people with various types of color vision deficiencies, the self-service device 105 may establish some default color enhancement modes, such as red-green color enhancement mode, blue-yellow color enhancement mode, and complete color enhancement mode.

In some embodiments, the red-green color enhancement mode may involve changing the color scheme of red and green colors to increase contract and/or improve visibility for individuals with red-green color vision deficiencies, such as adjusting the lightness/brightness or saturation of these colors to make them more distinguishable. In some embodiments, the blue-yellow color enhancement mode may involve adjusting the color scheme (e.g., lightness/brightness, saturation) of blue and yellow colors, adapting the display for individuals with blue-yellow color vision deficiencies. In some embodiments, within the red-green color enhancement mode and blue-yellow color enhancement mode, confusing colors, such as red, green, yellow, and blue, may be replaced with other colors that are more easily distinguished or with patterns, symbols, and text labels that offer alternative methods of differentiation. In some embodiments, the complete color enhancement mode may be designed for individuals with complete color vision deficiencies, where colors are substituted with symbols, patterns, or text labels.

In some embodiments, the default color enhancement modes may be represented by corresponding icons on the home screen of a self-service device 105. As a user 110 approaches the device 105, he or she can directly select the mode (e.g., by clicking the matching icon) that best fits his or her visual needs. For example, a user with red-green color vision deficiency may select the red-green color enhancement mode.

In some embodiments, instead of or in addition to choosing a default color enhancement mode, a user may transmit his or her color preferences directly to the self-service devices. In such configurations, color preferences may be predefined in a user's personal device 115 (e.g., a mobile phone) and then transmitted to the self-service device 105. Various methods may be used for the transmission, such as Near Field Communication (NFC), WiFi Direct, WiFi hotspot, Bluetooth, or even wired connections (e.g., USB-C). Upon receiving the user-defined color preferences, the self-service device 105 may adjust its display settings accordingly and generate a customized color enhancement mode for the user.

In some embodiments, before implementing the selected default color enhancement mode or the newly-generated customized color enhancement mode, a preview screen/window may pop up, showing the user 110 how the colors will change after implementation. In some embodiments, the preview screen/window may include toolbars that enable the user 110 to further refine or adjust the display settings to accommodate his or her visual needs.

In some embodiments, following the confirmation within the preview window, the color enhancement mode, such as the default color enhancement mode (with or without adjustments) or the newly-generated customized color enhancement mode, may be implemented by the self-service device 105. The mode may be maintained during one or more transactions for the user 110. For example, if the user 110 is engaged in a transaction at a self-checkout device, the selected color mode would be maintained as the user scans items, review his or her cart, and proceeds to payment. Similarly, if the user is using a kiosk station configured for providing information or services in retail environments, the color mode would be maintained as the user navigates through different screens or menus, which may include activities such as looking up information, filling out forms, or accessing certain services. The continuous application of the selected color mode may ensure uninterrupted interactions between the user 110 and the self-service device 105, allowing the user to clearly see and use the device through the entire transaction.

In some embodiments, upon detecting that the transaction is complete, the self-service device 105 may automatically revert back to the standard color mode. In some embodiments, the implemented color enhancement mode and/or the user's color preferences may be saved along with the user's profile in a database 125. The stored information may be used to facilitate a quick setup in future interactions. For example, a user may select one color enhancement mode while using a first self-service device (e.g., a kiosk when he or she enters the establishment). The selected color enhancement mode may be saved along with the user's profile. When the user uses a second self-service device at a later time (e.g., a self-checkout device during the same trip), the saved color enhancement mode may be automatically implemented on the second self-service device.

In the illustrated example, the self-service device 105 and the database 125 are remote from each other and communicate with each other via a network 130. Each of the devices may be implemented using discrete hardware systems. The network 130 may include or correspond to a wide area network (WAN), a local area network (LAN), the Internet, an intranet, or any combination of suitable communication mediums that may be available, and may include wired, wireless, or a combination of wired and wireless links. In some embodiments, the self-service device 105 and the database 125 may be local to each other (e.g., within the same local network and/or the same hardware system), and communicate with one another using any appropriate local communication medium, such as a local area network (LAN) (including a wireless local area network (WLAN)), hardwire, wireless link, or intranet, etc.

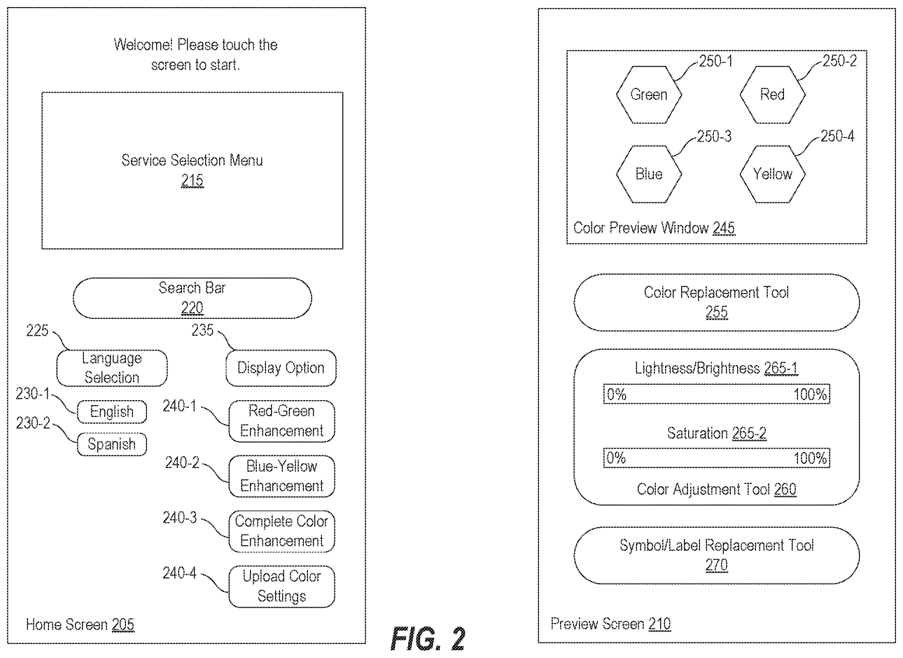

FIG. 2 depicts example Graphical User interfaces (GUIs) 205 and 210 designed for interactive selection and adjustment of color enhancement modes, according to some embodiments of the present disclosure.

In the illustration, the home screen 205 (also referred to in some embodiments as home GUI) serves as the initial interface displayed on a self-service device (e.g., 105 of FIG. 1) before any transaction begins. The home screen 205 provides access to the available services and settings of the self-service device as users initiate their interactions. As illustrated, the home screen 205 includes a service selection menu 215, which provides users with a list of available services or options offered by the device. Below the service selection menu 215, a search bar 220 is provided, which allows users to quickly find services or information they are interested in. As illustrated, the home screen 205 also includes a “language section” icon 225, below which users can choose between English 230-1 and Spanish 230-2. The language section feature is designed for quick language switching, and therefore enhances the device's accessibility. Adjacent to the “language section” icon 225, there is a “display option” icon 235, below which various default color enhancement modes are provided, such as red-green color enhancement mode 240-1, blue-yellow color enhancement mode 240-2, and complete color enhancement model 240-3. In some embodiments, the default color enhancement modes may include predefined data (e.g., setting the saturation of green to 70%), which is designed to adjust the display settings with one click to accommodate individuals with different types of color vision deficiencies. For example, when a user clicks the “red-green enhancement” icon 240-1, the display settings of the self-service device may be automatically adjusted to modify the color scheme (e.g., brightness/lightness, temperature, contrast, saturation) of red and green colors. In some embodiments, the adjustments may involve changes like adjusting the brightness/lightness or saturation levels of red and green colors (e.g., increasing red's brightness to a certain percentage, adjusting red's saturation levels). The adjustment aims to enhance visibility and contrast for users with red-green color vision deficiencies, and thus enable them to effectively distinguish the two colors. In some embodiments, the predefined adjustments within the red-green color enhancement mode may include replacing red or green color with other colors that are more easily distinguishable by individuals with color vision deficiencies, or with patterns, symbols, and text labels that offer alternative methods of differentiation. The one-click default color enhancement modes provide a quick and user-friendly way for individuals to adjust the display according to their visual needs.

The depicted example home screen 205, which depicts three default color enhancement modes, is provided for conceptual clarity. In some embodiments, depending on the system settings and user base, other default (or system-defined) color enhancement modes may also be established and shown on the home screen 205.

In the illustration, the home screen 205 further includes an “upload color setting” icon 240-4, which allows users to upload their color preferences (e.g., from a mobile device). In some embodiments, upon receiving these preferences, the self-service device may adjust its display settings automatically, and/or create a customized color enhancement model that is specifically designed to meet the user's needs.

In the illustration, the depicted example preview screen 210 (also referred to in some embodiments as preview GUI) may appear or pop up after the users select a default color enhancement mode (e.g., by clicking the “red-green enhancement” icon 240-1) or upload their color preferences. As illustrated, the preview screen 210 includes a color preview window 245, which features color swatches for green 250-1, red 250-2, blue 250-3, and yellow 250-4 colors. The color preview window 245 demonstrates how these colors will appear after the selected color enhancement mode is implemented. The visual representation provided by the color preview window 245 helps users to anticipate and understand the changes to the display settings.

Below the color preview window 245, as illustrated, the preview screen 210 also includes several toolbars designed for further refinement and customization of the display settings. These toolbars provide users with the flexibility to adjust the display settings according to their unique visual requirements. As illustrated, the preview screen 210 includes a color adjustment tool 235, a color adjustment tool 260, and a symbol/label replacement tool 270. In some embodiments, the color adjustment tool 235 may allow users to replace one color with another. For example, if certain shades of green are difficult to distinguish, users may replace these problematic green shades with more distinguishable colors (e.g., blue, purple). In some embodiments, the color adjustment tool 260 may enable users to adjust the brightness/lightness level 265-1 and/or saturation levels 265-2 of each color. In some embodiments, the symbol/label replacement tool 270 may offer the option to replace colors with patterns, symbols, or text labels. This tool may be useful for those with complete color blindness or severe color vision deficiencies, as it provides an alternative non-color-based method of differentiation.

The depicted example color preview window 245 that includes four color swatches (red, green, blue, and yellow) is provided for conceptual clarity. In some embodiments, additional color swatches for colors beyond these four primary ones may be included to satisfy a broader range of visual preferences and needs. The depicted example color adjustment tool 260 that offers options to adjust the brightness/lightness and saturation of each color is provided for conceptual clarity. In some embodiments, additional adjustments like hue, temperature, and contrast may be included to enable more granular control over the color settings.

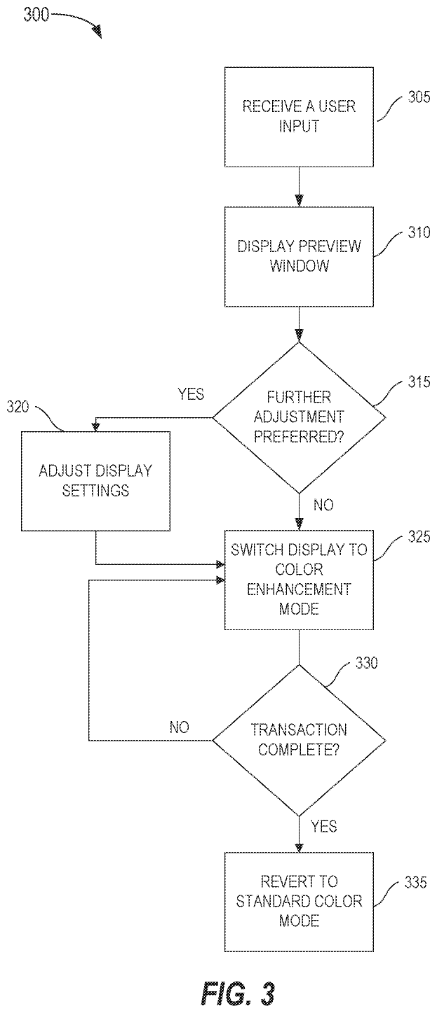

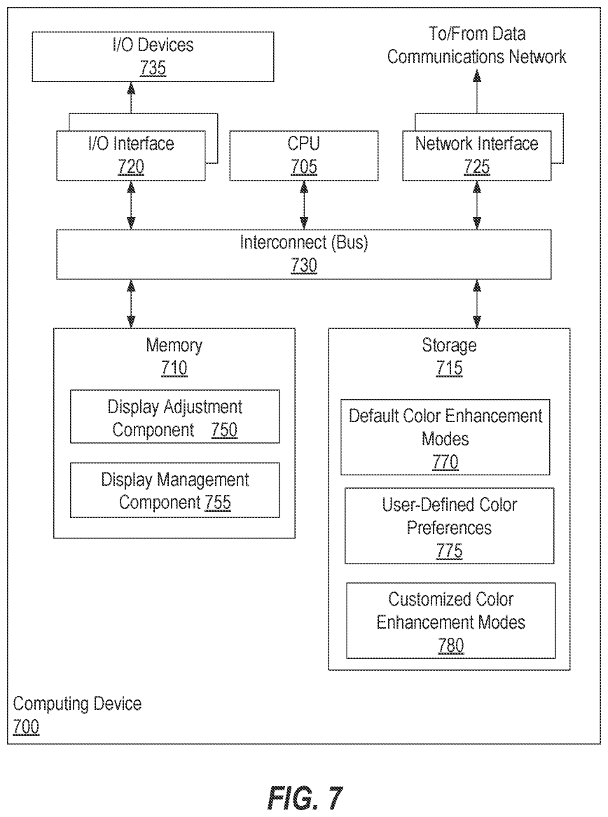

FIG. 3 depicts an example method 300 for interactively selecting and adjusting color enhancement modes based on user preferences, according to some embodiments of the present disclosure. In some embodiments, the example method 300 may be performed by one or more computing systems, such as the self-service device 105 as illustrated in FIG. 1, and/or the computing device 700 as illustrated in FIG. 7.

The method 300 begins at block 305, where a computing system (e.g., the self-service device 105 of FIG. 1) receives an input from a user, where the input indicates a default (or system-defined) color enhancement mode selected by the user. In some embodiments, the input is received when the user clicks the corresponding icon on the home screen (e.g., the home screen 205 of FIG. 2) of a self-service device. In some embodiments, the default color enhancement mode may include predefined data designed to adjust the display settings. In some embodiments, the computing system may provide three default color enhancement modes for selection, including the red-green color enhancement mode, the blue-yellow color enhancement mode, and the complete color enhancement mode, each configured to address challenges associated with different types of color vision deficiencies. For example, the red-green color enhancement mode is designed for individuals with red-green color vision deficiencies. When selected by a user, the computing system may automatically apply predefined adjustments to the display settings, such as changing the color scheme to enhance the distinction between red and green colors. In some embodiments, as discussed above, the adjustments may include increasing contrast between these two colors, adjusting saturation or brightness/lightness levels to make them more distinguishable, or replacing these colors with patterns, symbols, or text labels. The blue-yellow color enhancement mode is designed for individuals with blue-yellow color vision deficiencies. The mode may involve modifying the display settings (e.g., by adjusting contrast, temperature, saturation, or brightness/lightness) to make blue and yellow colors more distinct from each other. The complete color enhancement mode is designed for individuals with complete color blindness or severe color vision deficiencies. When selected by a user, the computing system may adjust its display settings by replacing colors with different patterns, symbols, or text labels.

At block 310, the computing system displays a preview window (e.g., the preview screen 210 of FIG. 2) to the user before fully implementing the selected color enhancement settings. In some embodiments, the preview window may include a section (e.g., the color preview window 245 of FIG. 2) that visually demonstrates how colors will appear after the implementation. In some embodiments, the preview window may include a feature that enables users to view the original color scheme and the modified one resulting from the implementation of the selected color enhancement mode. This feature may help users to better understand the extent of the color adjustments being made. In some embodiments, the preview window may further include one or more toolbars (e.g., the color replacement tool 255, the color adjustment tool 260, and the symbol/label replacement tool 270 as illustrated in FIG. 2) that enable users to further refine the display settings.

At block 315, the computing system checks user inputs (e.g., provided through using the toolbars within the preview window) to determine if further adjustments are preferred. If the computing system detects that the user has made additional adjustments, the method 300 proceeds to block 320, where the computing system modifies the display settings according to these user instructions. Once these adjustments are applied, the method 300 proceeds to block 325, where the computing system switches its display from the standard color mode to the selected color enhancement mode (with user-driven modifications). If the computing system determines no further adjustments are indicated by the user, the method 300 proceeds directly to block 325, where the computing system switches its display from the standard color mode to the selected color enhancement mode (without user-driven modifications).

At block 330, the computing system checks if a transaction for the user is complete, such as the completion of a checkout process on a self-checkout device or the end of a service session on a kiosk station. Once the computing system determines that the user's transaction is complete, the method 300 proceeds to block 335, where the computing system automatically reverts its display to the standard color mode. In some embodiments, the computing system may further store the user's preferences and/or the color mode that was implemented in the user's profile. This storage ensures that the user's customized settings can be quickly identified and retrieved for future interactions. If the transaction has not yet been completed, the method 300 returns to block 325, where the computing system continues to maintain the selected color enhancement mode. In some embodiments, the completion of a transaction may be determined by an explicit confirmation of session end (e.g., a user clicks the “End” button on the screen). In some embodiments, the completion of a transaction may be determined by no interaction (like clicking or screen touches) for a certain period of time. In some embodiments, the computing system may generate a pop-up window, asking the user if he or she needs more time. If no response is received within a certain period of time (e.g., 5 minutes), the system may conclude that the session ends, and automatically revert to the standard color mode.

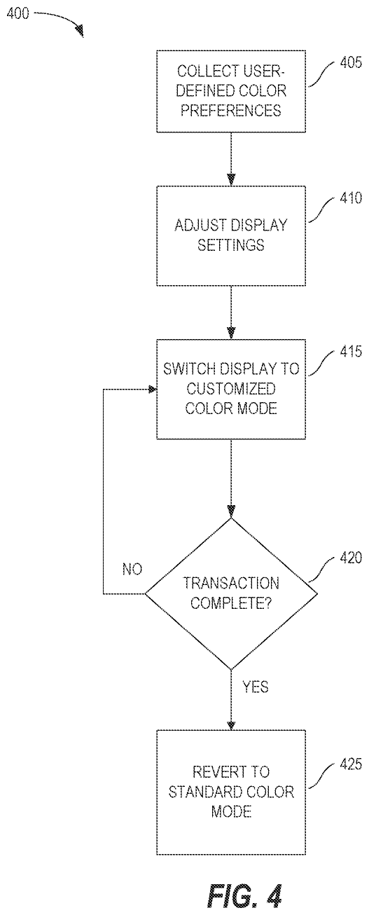

FIG. 4 depicts an example method 400 for generating customized color enhancement modes based on user preferences, according to some embodiments of the present disclosure. In some embodiments, the example method 300 may be performed by one or more computing systems, such as the self-service device 105 as illustrated in FIG. 1, and/or the computing device 700 as illustrated in FIG. 7.

At block 405, a computing system (e.g., the self-service device 105 of FIG. 1) collects user-defined color preferences. In some embodiments, the user-defined preferences may indicate the user's color vision deficiency type (e.g., protanomaly) and may include a set of parameters that instruct how colors should be displayed to accommodate the user's unique visual requirements. For example, the preferences may specify adjustments such as reducing the brightness of red to 30%, increasing the saturation of green to 80%, or replacing red with a more distinguishable color. In some embodiments, the user-defined color preferences may be transmitted from a user's personal device (e.g., a mobile phone). This allows the user to preset his or her preferences before approaching a self-service device. A variety of methods may be used for transmitting these preferences, such as Bluetooth, NFC, WiFi Direct, WiFi hotspot, or even wired connections.

At block 410, the computing system analyzes the user-defined preferences, and then proceeds to adjust its display settings to generate a customized color enhancement mode that aligns with the user's needs.

At block 415, the computing system switches its display from the standard color mode to the customized color enhancement mode. In some embodiments, to ensure the user's satisfaction with the display adjustments, the computing system may show a preview window (e.g., 210 of FIG. 2) to the user before the implementation. The preview window may provide a visual confirmation of how the color will appear with the customized settings. In some embodiments, the preview window may also include toolbars that enable the user to further refine the adjustments. Upon receiving the user's confirmation, the computing system may then move to implement the customized color enhancement mode.

At block 420, the computing system monitors its operations to determine if a transaction or session for the user is complete. In some embodiments, as discussed above, the completion of a transaction may be determined by user inactivity over a period of time (e.g., 5 minutes) or an explicit confirmation of session has ended. If the computing system determines that the transaction is complete, the method 400 proceeds to block 425, where the computing system automatically reverts the display to the standard color mode. If the computing system determines that the transaction has not yet been completed, the method 400 returns to block 415, where the computing system continues to maintain the customized color enhancement mode. In some embodiments, upon determining the completion of the transaction, the computing system may proceed to save the user-defined preferences and/or the customized color enhancement mode in storage (e.g., the database 125 of FIG. 1). The stored data may be used to facilitate quicker and more personalized interactions in future sessions for the user.

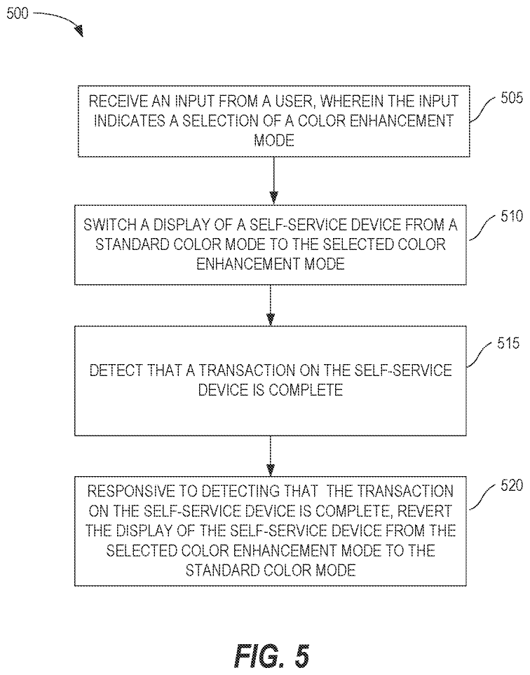

FIG. 5 is a flow diagram depicting an example method 500 for interactive selection and adjustment of color enhancement modes, according to some embodiments of the present disclosure.

At block 505, a computing system (e.g., the self-service device 105 of FIG. 1, or the computing device 700 of FIG. 7) receives an input, where the input indicates a selection of a color enhancement mode (as depicted by block 305 of FIG. 3). In some embodiments, the input may be received through an interface (e.g., the home screen 205 of FIG. 2) of the self-service device. In some embodiments, the selected color enhancement mode may include one of a red-green enhancement mode, designed to improve display visibility for users with red-green deficiency, a blue-yellow enhancement mode, designed to improve display visibility for users with blue-yellow color vision deficiency, or a complete color enhancement mode, designed to improve display visibility for users with complete color vision deficiency.

In some embodiments, the selected color enhancement mode may include at least one of replacing a first color by a second color, where the first color is different from the second color, adjusting a brightness level of a color, adjusting a saturation level of a color, or replacing a color with a pattern, a symbol or a text label.

At block 510, the computing system switches a display of a self-service device from a standard color mode to the selected color enhancement mode (as depicted by block 325 of FIG. 3).

At block 515, the computing system detects that a transaction on the self-service device is complete.

At block 520, responsive to detecting that the transaction on the self-service device is complete, the computing system reverts the display of the self-service device from the selected color enhancement mode to the standard color mode (as depicted by block 335 of FIG. 3).

In some embodiments, the computing system may further generate a preview window (e.g., the preview screen 210 of FIG. 2) on the self-service device, showing the selected color enhancement mode, receive instructions indicating one or more color preferences, and adjust the selected color enhancement mode according to the instructions within the preview window (as depicted by block 320 of FIG. 3).

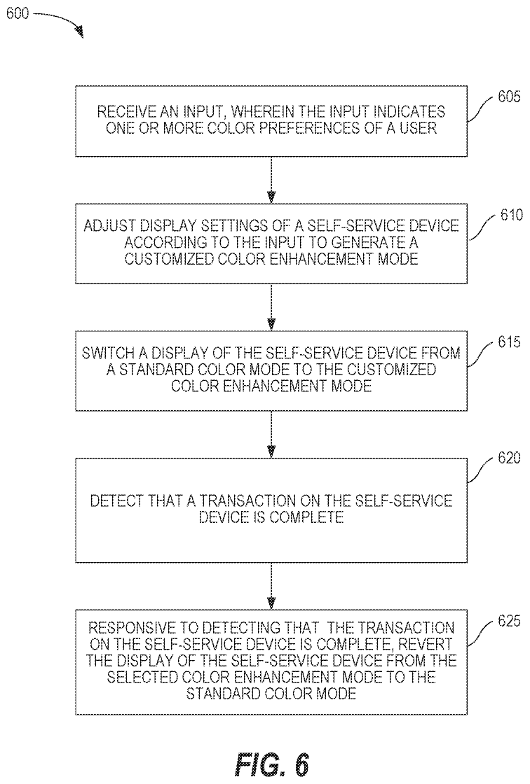

FIG. 6 is a flow diagram depicting an example method 600 for generation of customized color enhancement modes, according to some embodiments of the present disclosure.

At block 605, a computing system (e.g., the self-service device 105 of FIG. 1, or the computing device 700 of FIG. 7) receives an input, where the input indicates color preferences of the user (as depicted by block 405 of FIG. 4).

At block 610, the computing system adjusts display settings of a self-service device according to the input to generate a customized color enhancement mode (as depicted by block 410 of FIG. 4).

At block 615, the computing system switches the display of the self-service device from a standard color mode to the customized color enhancement mode (as depicted by block 415 of FIG. 4).

At block 620, the computing system detects that a transaction on the self-service device is complete.

At block 625, responsive to detecting that the transaction on the self-service device is complete, the computing system reverts the display of the self-service device from the customized color enhancement mode to the standard color mode (as depicted by block 425 of FIG. 4). In some embodiments, the color preferences of the user may comprise at least one of replacing a first color by a second color, where the first color is different from the second color, adjusting a brightness level of a color, adjusting a saturation level of a color, or replacing a color with a symbol or a text label, to accommodate color vision deficiencies of the user. In some embodiments, the second input may be transmitted by a mobile device (e.g., the mobile device 115 of FIG. 1) through a network connection.

FIG. 7 depicts an example computing device 700 configured to perform various aspects of the present disclosure, according to some embodiments of the present disclosure. The computing device 700 can be embodied as any computing device, such as the self-service device 105 as illustrated in FIG. 1, or a remote server (not depicted) that connects to the self-service device 105 via the network 130.

As illustrated, the computing device 700 includes a CPU 705, memory 710, storage 715, one or more network interfaces 725, and one or more I/O interfaces 720. In the illustrated embodiment, the CPU 705 retrieves and executes programming instructions stored in memory 710, as well as stores and retrieves application data residing in storage 715. The CPU 705 is generally representative of a single CPU and/or GPU, multiple CPUs and/or GPUs, a single CPU and/or GPU having multiple processing cores, and the like. The memory 710 is generally considered to be representative of a random access memory. Storage 715 may be any combination of disk drives, flash-based storage devices, and the like, and may include fixed and/or removable storage devices, such as fixed disk drives, removable memory cards, caches, optical storage, network attached storage (NAS), or storage area networks (SAN).

In some embodiments, I/O devices 735 (such as keyboards, monitors, etc.) are connected via the I/O interface(s) 720. Further, via the network interface 725, the computing device 700 can be communicatively coupled with one or more other devices and components (e.g., via a network, which may include the Internet, local network(s), and the like). As illustrated, the CPU 705, memory 710, storage 715, network interface(s) 725, and I/O interface(s) 720 are communicatively coupled by one or more buses 730.

In the illustrated embodiment, the memory 710 includes a display adjustment component 750 and a display management component 755. Although depicted as a discrete component for conceptual clarity, in some embodiments, the operations of the depicted component (and others not illustrated) may be combined or distributed across any number of components. Further, although depicted as software residing in memory 710, in some embodiments, the operations of the depicted components (and others not illustrated) may be implemented using hardware, software, or a combination of hardware and software.

In the illustrated embodiment, the display adjustment component 750 is configured to adjust the display settings based on user inputs. As discussed above, in some embodiments, the user input may include a default color enhancement mode (selected through an interface of the device), adjustments of colors (indicated within a preview window), or user-defined color preferences (uploaded by mobile devices). The display adjustment component 750 interprets the received inputs and modifies the display parameters accordingly. For example, in some embodiments, the display adjustment component 750 may adjust the brightness/lightness or saturation levels of one or more colors to increasing their contrast and visibility. In some embodiments, the display adjustment component 750 may replace these confusing colors (e.g., green, red, yellow, blue) with other colors that are more easily distinguished. In some embodiments, the display adjustment component 750 may use different patterns, symbols, or text labels to represent different colors.

In the illustrated embodiment, the display management component 755 is configured to manage the overall functioning of the display interface of the device. For example, in some embodiments, the display management component 755 may manage the switching between standard color mode and user-defined (customized) or system-defined (default) color enhancement modes. In some embodiments, the display management component 755 may monitor a transaction and upon determining the transaction is complete, revert the display interface to the standard color mode. In some embodiments, the display management component 755 may store user-defined preferences and/or the corresponding customized color enhancement mode for future reference.

In the illustrated example, the storage 715 may include default color enhancement modes 770, user-defined color preferences 775, and customized color enhancement modes 780. In some embodiments, the default color enhancement modes 770 may include red-green color enhancement mode, blue-yellow color enhancement mode, and complete color enhancement mode. In some embodiments, the user-defined color preferences 775 may refer to the instructions or inputs uploaded by users to the computing device 700, possibly through their personal devices (e.g., 115 of FIG. 1). The user-defined color preferences 775 may a set of parameters that instruct how color settings should be adjusted to accommodate the user's unique visual needs. In some embodiments, the customized color enhancement modes 780 may include the color modes generated directly based on the uploaded user-defined color preferences, and the color modes originate from a default color enhancement mode but include modifications made by users in the preview window.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

In the following, reference is made to embodiments presented in this disclosure. However, the scope of the present disclosure is not limited to the described embodiments. Instead, any combination of the following features and elements, whether related to different embodiments or not, is contemplated to implement and practice contemplated embodiments. Furthermore, although embodiments disclosed herein may achieve advantages over other possible solutions or over the prior art, whether or not an advantage is achieved by a given embodiment is not limiting of the scope of the present disclosure. Thus, the following aspects, features, embodiments and advantages are merely illustrative and are not considered elements or limitations of the appended claims except where explicitly recited in a claim(s).

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.”

The present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in an manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Embodiments of the disclosure may be provided to end users through a cloud computing infrastructure. Cloud computing generally refers to the provision of scalable computing resources as a service over a network. More formally, cloud computing may be defined as a computing capability that provides an abstraction between the computing resource and its underlying technical architecture (e.g., servers, storage, networks), enabling convenient, on-demand network access to a shared pool of configurable computing resources that can be rapidly provisioned and released with minimal management effort or service provider interaction. Thus, cloud computing allows a user to access virtual computing resources (e.g., storage, data, applications, and even complete virtualized computing systems) in “the cloud,” without regard for the underlying physical systems (or locations of those systems) used to provide the computing resources.

Typically, cloud computing resources are provided to a user on a pay-per-use basis, where users are charged for the computing resources actually used (e.g. an amount of storage space consumed by a user or a number of virtualized systems instantiated by the user). A user can access any of the resources that reside in the cloud at any time, and from anywhere across the Internet. In context of the present disclosure, a user may access applications (e.g., color adjustment application) or related data available in the cloud. For example, the fraud detection application may analyze user inputs and generate corresponding color enhancement modes through a cloud computing infrastructure, and store the relevant results in a storage location in the cloud. Doing so allows a user to access this information from any computing system attached to a network connected to the cloud (e.g., the Internet).

While the foregoing is directed to embodiments of the present disclosure, other and further embodiments of the disclosure may be devised without departing from the basic scope thereof, and the scope thereof is determined by the claims that follow.

1. A method comprising:
receiving an input, wherein the input indicates a selection of a color enhancement mode;
generating a preview window on a self-service device, wherein the preview window displays:
one or more color swatches, representing how one or more colors are affected by the selected color enhancement mode; and
one or more adjustment tools configured to adjust one or more color parameters, or to replace a color with a pattern, symbol or text label;
switching a display of the self-service device from a standard color mode to the selected color enhancement mode;
detecting that a transaction on the self-service device is complete; and
responsive to detecting that the transaction on the self-service device is complete, reverting the display of the self-service device from the selected color enhancement mode to the standard color mode.

2. The method of claim 1, wherein the input is received through an interface of the self-service device.

3. The method of claim 1, wherein the selected color enhancement mode includes one of (i) a red-green enhancement mode, designed to improve display visibility for users with red-green deficiency; (ii) a blue-yellow enhancement mode, designed to improve display visibility for users with blue-yellow color vision deficiency; or (iii) a complete color enhancement mode, designed to improve display visibility for users with complete color vision deficiency.

4. The method of claim 1, wherein the selected color enhancement mode includes at least one of (i) replacing a first color by a second color, wherein the first color is different from the second color; (ii) adjusting a brightness level of a color; (iii) adjusting a saturation level of a color; or (iv) replacing a color with a pattern, a symbol or a text label.

5. The method of claim 1, further comprising:
receiving a second input, wherein the second input indicates one or more color preferences of a user;
adjusting display settings of the self-service device according to the second input to generate a customized color enhancement mode;
switching the display of the self-service device from the standard color mode to the customized color enhancement mode;
detecting that the transaction on the self-service device is complete; and
responsive to detecting that the transaction on the self-service device is complete, reverting the display of the self-service device from the customized color enhancement mode to the standard color mode.

6. The method of claim 5, wherein the one or more color preferences of the user comprises at least one of (i) replacing a first color by a second color, wherein the first color is different from the second color, (ii) adjusting a brightness level of a color, (iii) adjusting a saturation level of a color, or (iv) replacing a color with a symbol or a text label, to accommodate color vision deficiencies of the user.

7. The method of claim 5, wherein the second input is transmitted by a mobile device through a network connection.

8. The method of claim 1, further comprising:
receiving instructions indicating one or more color preferences; and
adjusting the selected color enhancement mode according to the instructions within the preview window.

9. A system, comprising:
one or more processors;
one or more memories storing a program, which, when executed on any combination of the one or more processors, performs operations, the operations comprising:
receiving an input, wherein the input indicates a selection of a color enhancement mode;
generating a preview window on a self-service device, wherein the preview window displays:
one or more color swatches, representing how one or more colors are affected by the selected color enhancement mode; and
one or more adjustment tools configured to adjust one or more color parameters, or to replace a color with a pattern, symbol or text label;
switching a display of the self-service device from a standard color mode to the selected color enhancement mode;
detecting that a transaction on the self-service device is complete; and
responsive to detecting that the transaction on the self-service device is complete, reverting the display of the self-service device from the selected color enhancement mode to the standard color mode.

10. The system of claim 9, wherein the input is received through an interface of the self-service device.

11. The system of claim 9, wherein the selected color enhancement mode includes one of (i) a red-green enhancement mode, designed to improve display visibility for users with red-green deficiency; (ii) a blue-yellow enhancement mode, designed to improve display visibility for users with blue-yellow color vision deficiency; or (iii) a complete color enhancement mode, designed to improve display visibility for users with complete color vision deficiency.

12. The system of claim 9, wherein the selected color enhancement mode includes at least one of (i) replacing a first color by a second color, wherein the first color is different from the second color; (ii) adjusting a brightness level of a color; (iii) adjusting a saturation level of a color; or (iv) replacing a color with a pattern, a symbol or a text label.

13. The system of claim 9, wherein the program, which, when executed on any combination of the one or more processors, performs the operations further comprising:
receiving a second input, wherein the second input indicates one or more color preferences of a user;
adjusting display settings of the self-service device according to the second input to generate a customized color enhancement mode;
switching the display of the self-service device from the standard color mode to the customized color enhancement mode;
detecting that the transaction on the self-service device is complete; and
responsive to detecting that the transaction on the self-service device is complete, reverting the display of the self-service device from the customized color enhancement mode to the standard color mode.

14. The system of claim 13, wherein the one or more color preferences of the user comprises at least one of (i) replacing a first color by a second color, wherein the first color is different from the second color, (ii) adjusting a brightness level of a color, (iii) adjusting a saturation level of a color, or (iv) replacing a color with a symbol or a text label, to accommodate color vision deficiencies of the user.

15. The system of claim 13, wherein the second input is transmitted by a mobile device through a network connection.

16. The system of claim 9, wherein the program, which, when executed on any combination of the one or more processors, performs the operations further comprising:
receiving instructions indicating one or more color preferences; and
adjusting the selected color enhancement mode according to the instructions within the preview window.

17. One or more non-transitory computer-readable media containing, in any combination, computer program code that, when executed by operation of a computer system, performs operations comprising:
receiving an input, wherein the input indicates a selection of a color enhancement mode;
generating a preview window on a self-service device, wherein the preview window displays:
one or more color swatches, representing how one or more colors are affected by the selected color enhancement mode; and
one or more adjustment tools configured to adjust one or more color parameters, or to replace a color with a pattern, symbol or text label;
switching a display of the self-service device from a standard color mode to the selected color enhancement mode;
detecting that a transaction on the self-service device is complete; and
responsive to detecting that the transaction on the self-service device is complete, reverting the display of the self-service device from the selected color enhancement mode to the standard color mode.

18. The one or more non-transitory computer-readable media of claim 17, wherein the input is received through an interface of the self-service device.

19. The one or more non-transitory computer-readable media of claim 17, wherein the selected color enhancement mode include one of (i) a red-green enhancement mode, designed to improve display visibility for users with red-green deficiency; (ii) a blue-yellow enhancement mode, designed to improve display visibility for users with blue-yellow color vision deficiency; or (iii) a complete color enhancement mode, designed to improve display visibility for users with complete color vision deficiency.

20. The one or more non-transitory computer-readable media of claim 17, wherein the computer program code that, when executed by operation of a computer system, performs the operations further comprising:
receiving instructions indicating one or more color preferences; and
adjusting the selected color enhancement mode according to the instructions within the preview window.
